(19) United States
(12) Patent Application Publication
(10) Pub. No.: US 2008/0114943 A1
(43) Pub. Date: May 15, 2008

(54) Adding one or more computers to a multiple computer system

(76) Inventor: John M. Holt, Essex (GB)

Correspondence Address: PERKINS COIE LLP, P.O. BOX 2168, MENLO PARK, CA, 94026, US

(21) Appl. No.: 11/973,346

(22) Filed: Oct. 5, 2007

Related U.S. Application Data
(60) Provisional application No. 60/850,501, filed on Oct. 9, 2006.

(30) Foreign Application Priority Data
Oct. 5, 2006 (AU) 2006905531

(51) Int. Cl. G06F 12/00

(52) U.S. Cl. 711/147

(57) ABSTRACT

The addition of one or more additional computers to a multiple computer system having replicated shared memory (RSM) or partial or hybrid RSM, is disclosed. The or each additional computer (M4) has its independent local memory (502) initialised by the system to at least partially replicate the independent local memory orf the computers (M1-M3) of the multiple computer system.

The present application claims the benefit of priority to U.S. Provisional Application No. 60/850,501 (5027CQ-US) filed 9 Oct. 2006; and to Australian Provisional Application No. 2006 905 531 (5027CQ-AU) filed on 5 Oct. 2006, each of which are hereby incorporated herein by reference.

This application is related to concurrently filed U.S. Application entitled “Adding One or More Computers to a Multiple Computer System,” (Attorney Docket No. 61130-8031.US02 (5027CQ-US02)) which is hereby incorporated herein by reference.

### FIELD OF THE INVENTION

The present invention relates to adding one or multiple machines or computers to an existing operating plurality of machines in a replicated shared memory arrangement.

It is desirable in scalable computing systems, to be able to grow or increase the size of the computing system without requiring the system as a whole to be stopped and/or restarted. Examples of prior art computing systems that support the live adding of new computing resources to the computing system are large scale enterprise computing systems such as the 15K enterprise computing system from Sun Microsystems. In this prior art computing system, it is possible to add new processing elements consisting of CPU and memory to an existing running system without requiring that system, and the software executing on it, be stopped and restarted. Whilst these known techniques of the prior art work very well for these existing enterprise computing systems, they do not work for multiple computer systems operating as replicated shared arrangements.

### GENESIS OF THE INVENTION

The genesis of the present invention is a desire to dynamically add new computing resources to a running replicated shared memory system comprising a plurality of computers without that replicated shared memory system and the software executing on it, needing to be stopped or restarted.

### SUMMARY OF THE INVENTION

In accordance with a first aspect of the present invention there is disclosed a method of adding at least one additional computer to a replicated shared memory (RSM) multiple computer system or to a partial or hybrid RSM multiple computer system, said system comprising a plurality of computers each interconnected via a communications system and each operable to execute a different portion of an applications program written to execute on only a single computer, said method comprising the step of:

(i) initializing the memory of the or each said additional computer to at least partially replicate the memory contents of said plurality of computers in the or each said additional computer.

In accordance with a second aspect of the present invention there is disclosed a method of adding at least one additional computer to a replicated shared memory (RSM) multiple computer system or to a partial or hybrid RSM multiple computer system, said system comprising a plurality of computers each interconnected via a communications system and each operable to execute (or operating) a different portion of an application program written to execute on only a single computer, each of said computers comprising an independent local memory with at least one application memory location replicated in each of said independent local memories, said method comprising the step of:

(i) initializing the local independent memory of the or each said additional computer to at least partially replicate the replicated application memory contents of said plurality of computers in the or each said additional computer.

Systems, hardware, a single computer, a multiple computer system and a computer program product comprising a set of instructions stored in a storage medium and arranged when loaded in a computer to have the computer execute the instructions and thereby carry out the above method, are also disclosed.

### BRIEF DESCRIPTION OF THE DRAWINGS

Preferred embodiments of the invention will now be described, by way of example only, with reference to the accompanying drawings in which:

FIG. 1 is a schematic representation of a first prior art SMP system,

FIG. 2 is a schematic representation of a second prior art SMP system,

FIG. 3 is a schematic representation of a prior art distributed shared memory (DSM) system,

FIG. 4 is a schematic representation of a prior art replicated shared memory (RSM) system,

FIG. 4A is a similar schematic representation of a partial or hybrid RSM multiple computer system

FIG. 5 is a schematic representation of the RSM system of the preferred embodiment,

FIG. 6 is a flow chart of the steps required to add an additional computer to the system of FIG. 5,

FIG. 7 is a flow chart similar to that of FIG. 6 but of another embodiment,

FIG. 8 is a flow chart illustrating the response to the steps of FIG. 7,

FIG. 9 is a schematic representation similar to that of FIG. 5 but illustrating partial or hybrid RSM, and

FIG. 10 is a flow chart illustrating the steps required to add an additional computer to the system of FIG. 9.

### DETAILED DESCRIPTION

As seen in FIG. 1, a prior art arrangement of a symmetrical multi-processing (SMP) computing system is shown. In this figure, a global memory 100 is provided which is able to be accessed and addressed by each one of, or some plurality of, CPU devices 101. An additional CPU 102 to be added is also shown. In this prior art arrangement of a symmetrical multi-processing machine, the additional CPU 102 is able to be transparently added to the executing computing system consisting of memory 100 in a relatively straightforward fashion, as all available memory used by the application is already resident in memory 100 which is globally accessible by all CPUs including the newly added CPU 102.

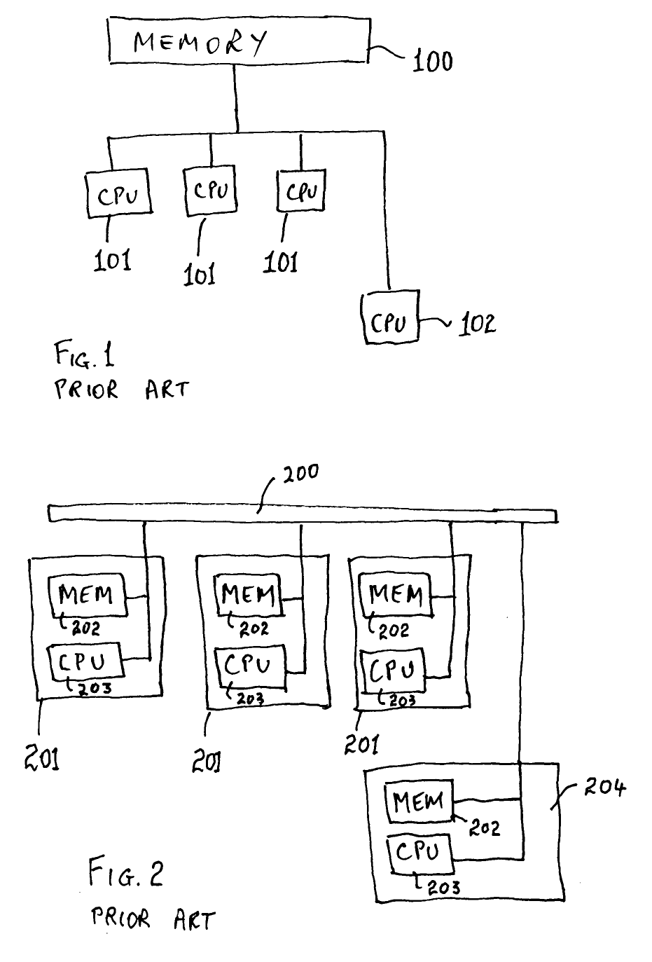

FIG. 2 shows an alternative prior art arrangement of an alternative symmetric multi-processing computer system formed from three processing elements 201 each of which has an interconnected memory 202 and a central processor unit (CPU) 203. The three processing elements 201 are in turn connected to a shared memory bus 200. This shared memory bus 200 allows any CPU 203 of any processing element to transparently access any memory location on any other processing element. Thus in this alternative symmetric multi-processing arrangement, there exists a global shared memory distributed across a plurality of individual memories 202. All CPU's 203 may access this global memory. Lastly, an additional processing element 204, is provided also consisting of a memory 202 and CPU 203. This additional processing element 204 is able to be attached to the shared memory bus 200, whilst the computing system consisting of the processing elements 201 is executing. Thus the goal of transparently adding computing capacity to the computing system is accomplished.

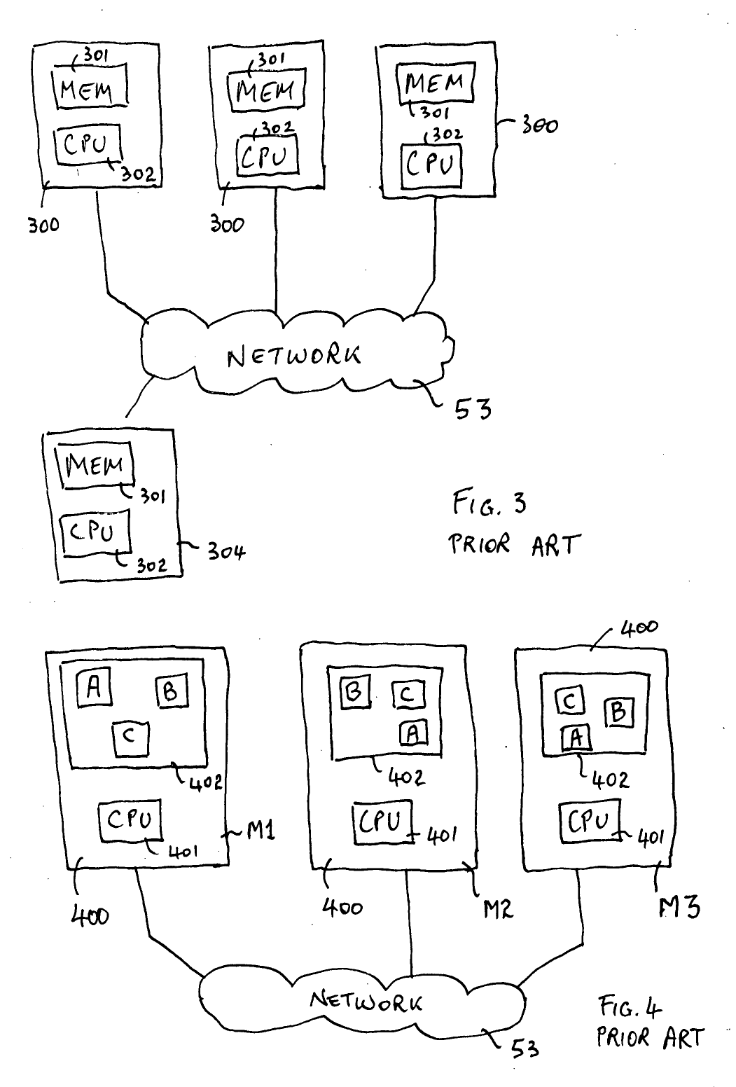

Turning now to FIG. 3, a further prior art arrangement is shown. In this distributed shared memory (DSM) arrangement, a plurality of machines 300 are shown interconnected via a communications network 53. An additional machine 304 is also provided. Each of the machines 300, consists of a memory 301 and one or more CPU's 302. As these machines are configured in a distributed shared memory arrangement, any CPU 302 is able to transparently access any memory location on any one of the plurality of machines 300 by means of communicating via the network 53. The additional machine 304, also consisting of memory 301 and one or more CPU's 302, is able to be connected to network 53 and joined to the distributed shared memory arrangement of the machines 300 in a transparent manner whilst they are executing without requiring the machines 300 to be stopped or restarted. Thus the goal of transparently adding new computing resources to an existing operating plurality of computers, in this instance a plurality of computing systems 300, is achieved with this prior art system.

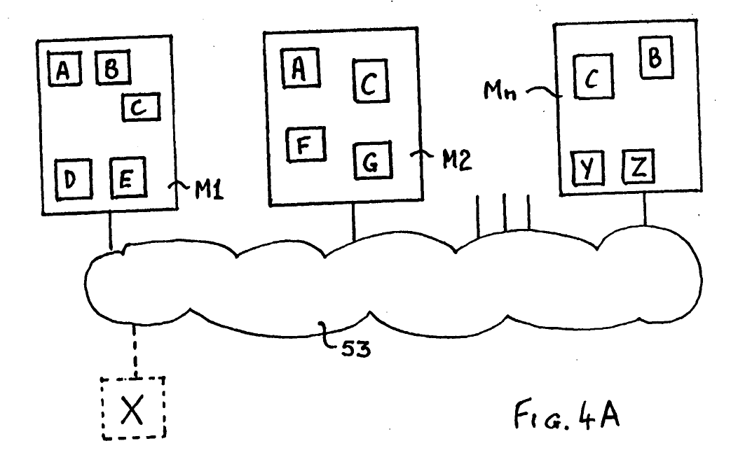

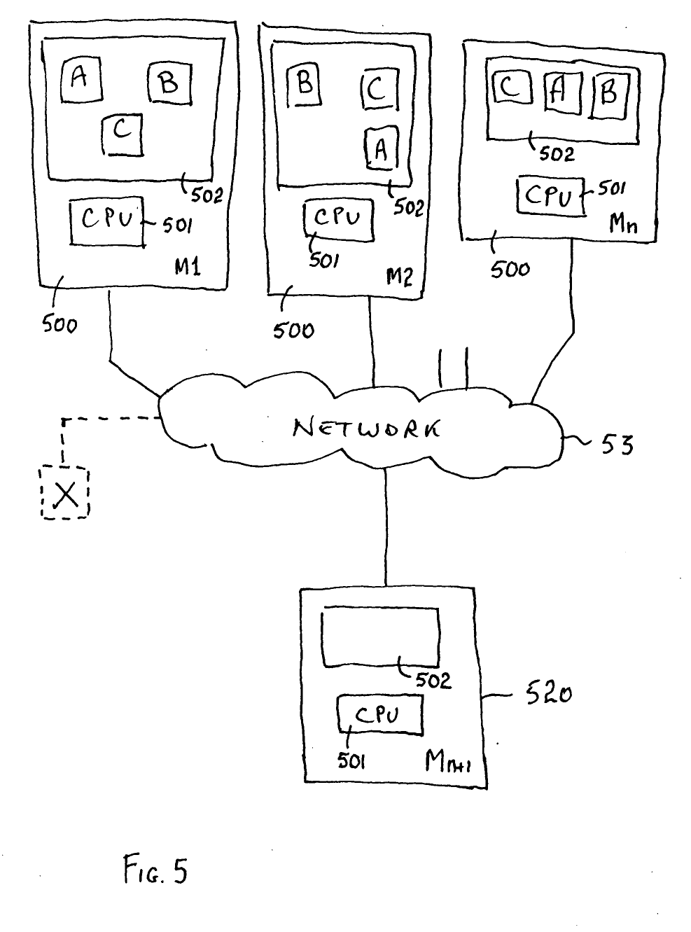

However, as seen in FIG. 4, a plurality of machines in a replicated shared memory (RSM) arrangement is shown. In the arrangement of FIG. 4, three machines 400 are provided. Each machine consists of one or more CPU's 401 as well as an independent local memory 402. These three machines 400 are interconnected via a communications network 53. FIG. 4 shows a replicated shared memory arrangement with three replicated application memory locations/contents, namely, replicated application memory location/content A, replicated application memory location/content B and replicated application memory location/content C. These three replicated application memory locations/contents are replicated on each of the independent local memories 402 of each of the machines 400. Unlike either of the three prior art systems shown in FIGS. 1,2 and 3, the replicated shared memory system shown in FIG. 4, cannot have additional computing capacity, in this instance, one or more machines added to it, as takes place in either of the three previous prior art systems. This is because replicated shared memory systems consisting of a plurality of machines cannot make use of the known prior art techniques of adding additional machines or computation resources to an existing operating replicated shared memory multiple computer system since there does not exist a single global shared memory as does exist in each of the previous three prior art arrangements. Thus, new computing resources cannot be transparently added to a replicated shared memory multiple computer system independent of, or uncoordinated with, the replicated memory system/arrangement of the computing arrangement of FIG. 4. As the CPU's 401 of the machines 400 used in a replicated shared memory arrangement such as the one shown in FIG. 4 can only access the local independent memory 402 of the same machine, the addition of a new machine to the operating plurality of machines, requires that some or all of the application memory of one or more of the existing machines 400 be replicated in the local independent memory of any new machine.

Therefore, it is desirable to conceive of a way to add additional computing resources or machines to a plurality of machines in a replicated shared memory arrangement, without requiring the existing operating plurality of machines (or computers or nodes) to be stopped or restarted.

Briefly, the arrangement of the replicated shared memory system of FIG. 4 allows a single application program written for, and intended to be run on, a single machine, to be substantially simultaneously executed on a plurality of machines, each with independent local memories, accessible only by the corresponding portion of the application program executing on that machine, and interconnected via the network 53. In International Patent Application No PCT/AU2005/001641 (WO2006/110,937) (Attorney Ref 5027F-D1-WO) to which U.S. patent application Ser. No. 11/259,885 entitled: “Computer Architecture Method of Operation for Multi-Computer Distributed Processing and Co-ordinated Memory and Asset Handling” corresponds, a technique is disclosed to detect modifications or manipulations made to a replicated memory location, such as a write to a replicated memory location A by machine M1 and correspondingly propagate this changed value written by machine M1 to the other machines M2 and M3 (or Mn where there is more than three machines) which each have a local replica of memory location A. This result is achieved by detecting write instructions in the executable object code of the application to be run that write to a replicated memory location, such as memory location A, and modifying the executable object code of the application program, at the point corresponding to each such detected write operation, such that new instructions are inserted to additionally record, mark, tag, or by some such other recording means indicate that the value of the written memory location has changed.

An alternative arrangement is that illustrated in FIG. 4A and termed partial or hybrid replicated shared memory (RSM). Here memory location A is replicated on computers or machines M1 and M2, memory location B is replicated on machines M1 and M3, and memory location C is replicated on machines M1, M2 and M3. However, the memory locations D and E are present only on machine M1, the memory locations F and G are present only on machine M2, and the memory locations Y and Z are present only on machine M3. Such an arrangement is disclosed in Australian Patent Application No. 2005 905 582 Attorney Ref 50271 (to which U.S. patent application Ser. No. 11/583,958 (60/730,543) and PCT/AU2006/001447 (WO2007/041762) correspond). In such a partial or hybrid RSM systems changes made by one computer to memory locations which are not replicated on any other computer do not need to be updated at all. Furthermore, a change made by any one computer to a memory location which is only replicated on some computers of the multiple computer system need only be propagated or updated to those some computers (and not to all other computers).

Consequently, for both RSM and partial RSM, a background thread, task, or process is able to, at a later stage, propagate the changed value to the other machines which also replicate the written to memory location, such that subject to an update and propagation delay, the memory contents of the written to replicated application memory location on all of the machines on which a replica exists, are substantially identical. Various other alternative arrangements are also disclosed in the abovementioned specifications.

Turning now to FIG. 5, a replicated shared memory arrangement of the preferred embodiment is shown consisting of a number of machines. This arrangement of machines consists of machines M1, M2 . . . Mn which are interconnected by a communications network 53. It is to be understood that “n” is an integer greater than or equal to two. Also, preferably there is a server machine X. A new machine 520 to be added to the system is shown and labelled as machine Mn+1. This additional machine 520 is a new machine that is to be added to the existing operating plurality of machines M1, M2 . . . Mn. Looking closer at the three operating machines, it is apparent that there are three replicated application memory locations/contents replicated on each of the machines, namely replicated application memory locations/contents A, B, and C. Machine Mn+1 however, as it is a new machine and has not yet been added to the operating plurality, has an independent local memory 502 which is empty (or otherwise unassigned) of replicated application memory locations/contents as indicated by the absence of labelled alphabetic replicated application memory locations/contents within the memory 502.

The preferable, but optional, server machine X provides various housekeeping functions on behalf of the operating plurality of machines. Because it is not essential, machine X is illustrated in broken lines. Among such housekeeping and similar tasks performed by the optional machine X is, or may be, the management of a list of machines considered to be part of the plurality of operating machines in a replicated shared memory arrangement. When performing such a task, machine X is used to signal to the operating machines the existence and availability of new computing resources such as machine Mn+1. If machine X is not present, these tasks are allocated to one of the other machines M1, . . . Mn, or a combination of the other machines M1, . . . Mn.

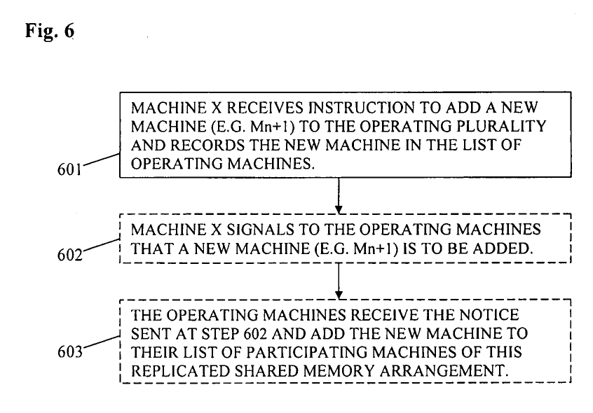

Turning to FIG. 6, one embodiment of the steps required to implement the addition of machine Mn+1 is shown. In FIG. 6, three steps are shown in flowchart form. Step 601, the first step, takes place when machine X receives an instruction to add a new machine such as machine Mn+1 of FIG. 5, to an existing operating plurality of machines, for example machines 500 of FIG. 5. At step 602, machine X signals to the operating machines, such as machines 500 of FIG. 5, that a new machine, such as machine 520 of FIG. 5, is to be added to the operating plurality via the network 53. Next at step 603, each of the machines of the operating plurality, receives a notification sent out by machine X in step 602 via network 53, and correspondingly adds a record of the existence and identity of the new machine 520 of FIG. 5 to their list of machines that are part of this replicated shared memory arrangement.

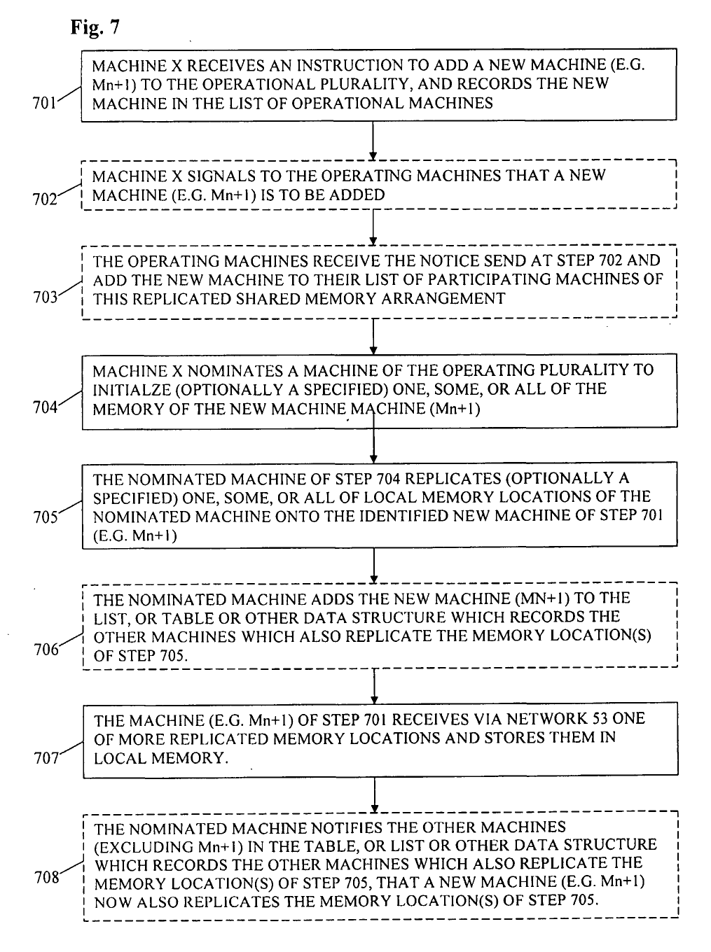

In FIG. 7, the steps required for a second (and improved) embodiment of the present invention is shown. In FIG. 7, the first three steps, 701, 702, and 703 are common with FIG. 6. However, in this alternative arrangement, steps 702, and 703 are indicated as optional as shown by their broken outlines.

Next, step 704 takes place. At step 704, machine X nominates a machine of the operating plurality of machines M1, M2, . . . Mn to initialise some of, or all of, the memory of machine Mn+1. Preferably, machine X instructs the nominated machine of the identity of the replica application memory location(s)/content(s) to be initialised on the new machine Mn+1.

At step 705, a nominated machine, having been nominated by machine X at step 704, proceeds to replicate one or optionally, a plurality of, its local replica application memory locations/contents, onto machine Mn+1. Specifically, at step 705, the nominated machine commences a replica initialization of one, some, or all of the replica application memory location(s)/content(s) of the nominated machine, to the new machine Mn+1. The nominated machine does this by transmitting the current value(s) or content(s) of the local/resident replica application memory location(s)/content(s) of the nominated machine, to the new machine.

Preferably, such replica initialization transmission transmits not only the current value(s) or content(s) of the relevant replica application memory location(s)/content(s) of the nominated computer, but also the global name (or names) or other global identity(s) or identifier(s) which identifies all of the corresponding replica application memory location(s)/content(s) of all machines.

Corresponding to step 705, step 706 takes place. At step 706, the nominated machine, that is the machine nominated at step 704 by machine X, adds a record of the existence and identity of the new machine Mn+1 to the local/resident list(s) or table(s) or other record(s) of other machines which also replicate the initialised replica application memory location(s)/content(s) of step 705.

Next, at step 707, the newly added machine, such as a machine Mn+1, receives via network 53, the replica initialisation transmission(s) containing the global identity or other global identifier and associated content(s)/value(s) of one or more replicated application memory locations/contents, sent to it by the nominated machine at step 705, and stores the received replica application memory location/content/values and associated identifier(s) in the local application memory of the local memory 502. Exactly what local memory storage arrangement, memory format, memory layout, memory structure or the like is utilised by the new machine Mn+1 to store the received replica application memory location/content/values and associated identifier(s) in the local application memory of the local memory 502 is not important to this invention, so long as the new machine Mn+1 is able to maintain a functional correspondence between its local/resident replica application memory locations/contents and corresponding replica application memory locations/contents of other machine(s).

The replicated memory location content(s) received via network 53, may be transmitted in multiple ways and means. However, exactly how the transmission of the replica application memory locations/contents is to take place, is not important for the present invention, so long as the replica application memory locations/contents are transmitted and appropriately received by the new machine Mn+1.

Typically, the transmitted replicated memory location content(s) will consist of a replicated/replica application memory location/content identifier, address, or other globally unique address or identifier to associated corresponding replica application memory locations/contents of the plural machines, and also the current replica memory value corresponding to that identified replica application memory location/content. Furthermore, in addition to a replica application memory location/content identifier, and associated replica memory value, one or more additional values or contents associated and/or stored with each replicated/replica application memory location/content may also be optionally sent by the nominated machine, and/or received by the new machine, and/or stored by the new machine, such as in its local memory 502. For example, in addition to a replica application memory location/content identifier, and an associated replica memory value, a table or other record or list identifying which other machines also replicate the same replicated application memory location/content may also optionally be sent, received, and stored.

Preferably, such a received table, list, record, or the like includes a list of all machines on which corresponding replica application memory location(s)/content(s) reside, including the new machine Mn+1. Alternatively, such a received table, list, record, or the like may exclude the new machine Mn+1. Optionally, when the received table, list, record or the like does not include the new machine Mn+1, machine Mn+1 may chose to add the identity, address, or other identifier of the new machine Mn+1 to such table, list, record, or the like stored in its local memory 502.

Finally at step 708, a nominated machine, notifies the other machines (preferably excluding the new machine Mn+1) in the table or list or other record of the other machines on which corresponding replica application memory location(s)/content(s) reside (including potentially multiple tables, lists, or records associated with multiple initialised replicated application memory locations/contents), that the new machine, Mn+1 now also replicates the initialised replicated application memory location(s)/content(s).

In FIG. 7, steps 706 and 708 are optional and therefore are illustrated by broken lines. An example of a situation where steps 706 and 708 would be not executed is an arrangement whereby the operating plurality of machines of FIG. 5, that is machines 500, consisted of only a single machine. The dotted outline of the boxes of 706 and 708 indicate that these steps are optional. Various other alternative embodiments may be conceived whereby these steps are excluded. For example, the server machine X can be notified and it then notifies the other machines.

Additionally, the steps of FIG. 7 may take place in various orders other than that depicted specifically in FIG. 7. For example, steps 706 and 708 may take place (either both of, or one of) prior to step 705. Also for example, step 705 may take place immediately prior to step 707. Various other combinations and arrangements by those skilled in the computing arts without departing from the scope of the present invention, and all such various other combinations and arrangements are to be included within the scope of the present invention.

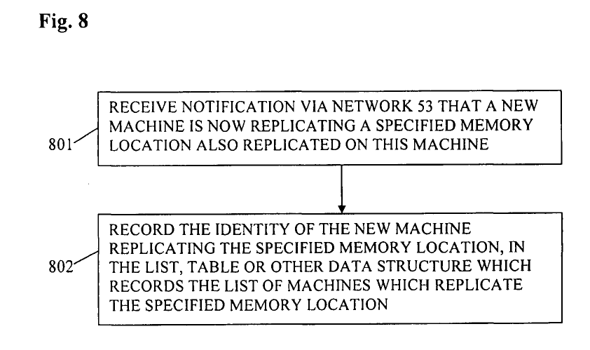

The responses of the other machines will now be described with reference to FIG. 8. In FIG. 8, step 801 corresponds to the receipt of a notification by one of the other machines that a new machine (e.g. machine Mn+1) is now replicating a specified/identified replicated application memory location/content which is also replicated on this one machine (that is, the machine to which step 801 corresponds). At step 802, the machine that received the notification of step 801, records the identity of the new machine replicating the specified/identified replicated application memory location/content (e.g. machine Mn+1) in the list, table, record, or other data structure which records the list of machines on which corresponding replica application memory location(s)/content(s) reside (that is, the machines which replicate the specified/identified replicated application memory location(s)/content(s)). Step 801, corresponds to the receipt of a notification transmitted by a machine executing step 706. Finally, with reference to both FIGS. 7 and 8, various different data structure arrangements may be used to record the list of machines which replicate specified/identified replicated application memory location(s)/content(s). The precise data structure or recording arrangements used by each machine is not important to this invention, but rather what is important is that a record (or list, or table, or the like) is kept and is able to be amended in accordance with the steps as explained above.

Thus preferably, there is associated with each replicated application memory location/content, a table, list, record or the like which identifies the machines on which corresponding replica application memory location(s)/content(s) reside, and such a table (or the like) is preferably stored in the local memory of each machine in which corresponding replica application memory location(s)/content(s) reside.

However alternative associations and correspondences between the abovedescribed tables, lists, records, or the like, and replicated application memory location(s)/content(s) are provided by this invention. Specifically, in addition to the above described “one-to-one” association of a single table, list, record, or the like with each single replicated application memory location/content, alternative arrangements are provided where a single table, list, record, or the like may be associated with two or more replicated application memory locations/contents. For example, it is provided in alternative embodiments that a single table, list, record, or the like may be stored and/or transmitted in accordance with the methods of this invention for a related set of plural replicated application memory locations/contents, such as for example plural replicated memory locations including an array data structure, or an object, or a class, or a “struct”, or a virtual memory page, or other structured data type having two or more related and/or associated replicated application memory locations/contents.

And further preferably, the above described tables, lists, records, or the like identifying the machines of the plurality on which corresponding replica application memory locations reside, are utilised during replica memory update transmissions. Specifically, an abovedescribed list, table, record, or the like is preferably utilised to address replica memory update transmissions to those machines on which corresponding replica application memory location(s)/content(s) reside.

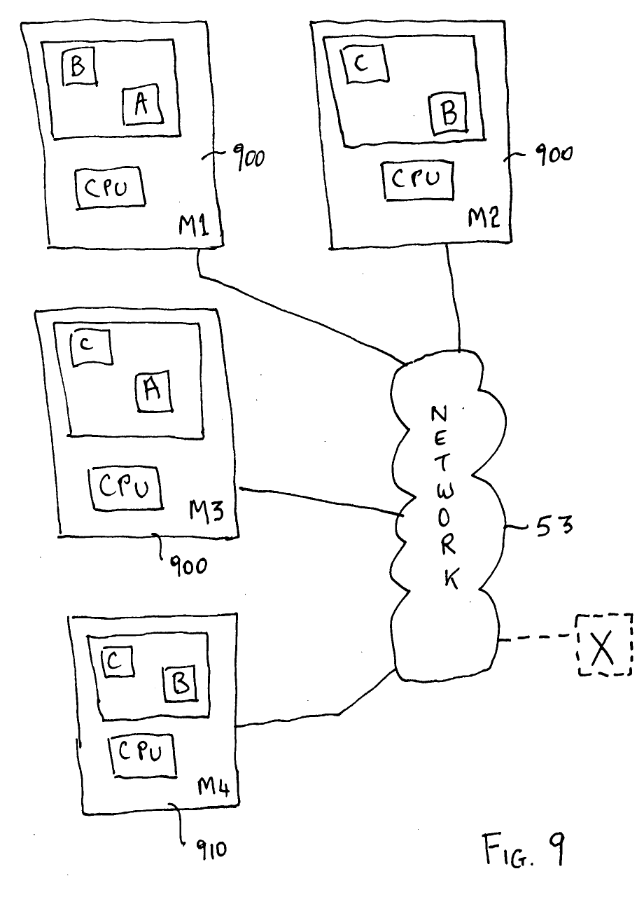

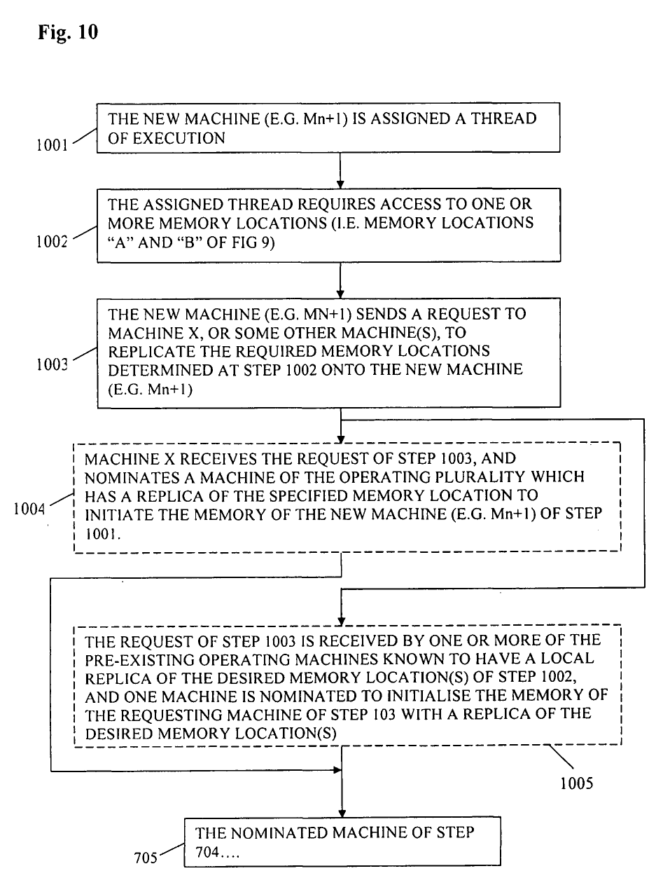

Turning now to FIG. 9, an arrangement of a plurality of machines with partial or particular hybrid RSM is shown. In this situation, a group of machines 900, namely machines M1, M2, M3, correspond to the machines of the pre-existing operating plurality. Machine 910, also indicated as machine M4, is a newly added machine to the existing operating plurality of machines 900. In accordance with the steps of FIGS. 6, 7 and 8, a symbolic representation of the replication of replicated application memory locations/contents “B” and “C” onto the new machine M4 is shown. Importantly, it is noticed that each of the machines 900 have different combinations of replicated application memory locations/contents. Namely machine M1 has replicated application memory locations/contents A and B. Machine M2 has replicated application memory locations/contents B and C, and machine M3 has replicated application memory locations/contents A and C. Also a server machine X is shown.

Corresponding to the steps of FIG. 6 where machine M2 is nominated by machine X in accordance with step 704, machine M2 in turn initialises the new machine M4 with its replicated application memory locations/contents C and B (corresponding to steps 705 and 707). Thus it is seen in machine M4, that machine M4 replicates those replicated application memory locations/contents sent to it by machine M2, namely replicated application memory locations/contents B and C. Obviously then, various other resulting replicated application memory locations/contents arrangements in machine M4 can be created depending upon which machine of the operating plurality M1, M2, and M3 is chosen (nominated) by server machine X to initialise the new machine M4. Thus, if machine X choses machine M1 to initialise the new machine M4, then machine M4 would come to have the replicated application memory locations/contents A and B instead.

The arrangement of FIG. 9 shows the new machine M4 being initialised with both of the replicated application memory locations/contents of the nominated machine M4. However, this is not a requirement of this invention. Instead, any lesser number or quantity of replicated application memory locations/contents of a nominated machine may be replicated (initialised) on a new machine. Thus, in an alternative of FIG. 9, it is possible that some subset of all replica application memory locations/contents of the nominated machine are replicated onto the new machine. So for example, with reference to FIG. 9, in such an alternative arrangement where some subset of all replica application memory locations/contents of the nominated machine are replicated (initialised) in the new machine, replicated application memory location/content “B” may be chosen to be initialised/replicated by machine M2 to machine M4, and thereby machine M4 would only include a replica application memory location/content “B” and not a replica application memory location/content “C”.

Additionally if desired, in more sophisticated arrangements the server machine X can choose to nominate more than one machine to initialise machine M4, such as by instructing one machine to initialise machine M4 with one replicated application memory location/content, and instructing another machine to initialise machine M4 with a different replicated application memory location/content. Such an alternative arrangement has the advantage that, machine X is able to choose/nominate which replicated application memory locations/contents are to be replicated on the new machine M4, if it is advantageous not to replicate all (or some subset of all) the replicated application memory locations/contents of a nominated machine.

With reference to FIG. 10, the steps required to implement a still further alternative embodiment of the invention are shown. In this alternative embodiment, rather than replicating all replicated application memory locations/contents of a nominated machine, or some subset of all replicated application memory locations/contents of one or more nominated machines, the replicated application memory locations/contents that are initialised and replicated on the new machine M4, can be chosen and determined not by server machine X but by the workload that the new machine M4 is to execute. Thus, in this alternative arrangement, a threaded execution model can be advantageously used.

In such a threaded execution model, one or more application threads of the application program can be assigned to the new machine M4 (potentially by the server machine X, or alternatively some other machine(s)), corresponding to that machine being connected to network 53 and added to the operating plurality of machines. In this alternative arrangement then, it is possible for machine M4 to be assigned one or more threads of execution of the application program in a threaded execution model, without yet having some or all of the replicated application memory locations/contents necessary to execute the assigned application thread or threads. Thus in such an arrangement, the steps necessary to bring this additional machine with its assigned application threads into an operable state in the replicated shared memory system are shown in FIG. 10.

Step 1001 in FIG. 10 corresponds to a newly available machine, such as a machine Mn+1, being assigned an application thread of execution. This assigned application thread, may be either a new application thread that has not yet commenced execution, or an existing application thread migrated to the new machine from one of the other operating machines and that has already commenced execution (or is to commence execution).

At step 1002, the replicated application memory locations/contents required by the application thread assigned in step 1001 are determined. This determination of required replicated application memory locations/contents can take place prior to the execution of the assigned application thread of step 1001. Or alternatively, the assigned application thread of step 1001, can start execution on the new machine Mn+1 until such a time that it is or may be determined during execution that the application thread requires a specific replicated application memory location/content not presently replicated on the new machine Mn+1.

Regardless of which alternative means of determining the replicated application memory location(s)/content(s) required by the application thread assigned in step 101 is used, at step 1003, the new machine Mn+1 sends a request to one of multiple destinations requesting that it be initialised with the replicated application memory location(s)/content(s) that has been determined to be needed. These various destinations can include server machine X, or one or more of the other machines of the operating plurality. Step 1004 corresponds to server machine X being the chosen destination of the request of step 1003. Alternatively step 1005 corresponds to one or more of the machines of the operating plurality of machines being the chosen destination of the request of step 1003.

At step 1004, machine X receives the request of step 1003, and nominates a machine of the operating plurality which has a local/resident replica of the specified replicated application memory location(s)/content(s) to initialise the memory of machine Mn+1. After step 1004 of FIG. 10 takes place, step 705 of FIG. 7 occurs, and thereby the subsequent steps of FIG. 7 also occur in turn. Importantly, the replicated application memory location(s)/content(s) that the nominated machine replicates onto machine Mn+1 at step 705, is or are the replicated application memory location(s)/content(s) determined at step 1002.

Alternatively, at step 1005, the request or requests of step 1003 are sent either directly to one of the machines of the operating plurality which replicated the determined replicated application memory location(s)/content(s) of step 1002, or can optionally, be broadcast to some subset of all, or all of, the operating machines. Regardless of which alternative is used, or various combinations of alternatives, corresponding to the receipt of request 1003 sent by the new machine Mn+1 to one of the machines on which the determined replicated application memory location(s)/content(s) of step 1002 is replicated, step 705 executes with regard to the specified replicated application memory location(s)/content(s) of step 1003.

To summarize, there is disclosed a method of adding at least one additional computer to a replicated shared memory (RSM) multiple computer system or to a partial or hybrid RSM multiple computer system, the system comprising a plurality of computers each interconnected via a communications system and each operable to execute (or operating/executing) a different portion of an application program written to execute on only a single computer, each of said computers comprising an independent local memory with at least one application memory location replicated in each of said independent local memories and updated to remain substantially similar, the method comprising the step of:

(i) initializing the local independent memory of the or each the additional computer to at least partially replicate the replicated application memory locations/contents of the plurality of computers in the or each additional computer.

Preferably the method includes the further step of:

(ii) in step (i) initializing the local independent memory of the or each additional computer to substantially fully replicate the replicated application memory locations/content of the multiple computer systems.

Preferably the method includes the further step of:

(iii) carrying out step (ii) in a plurality of stages.

Preferably at each of the stages the replicated application memory locations/contents of a different one of the computers of the system are replicated in the or each additional computer.

Preferably the method also includes the step of:

(iv) determining which replicated application memory locations/contents of the computers of the system are to be replicated in the or each additional computer on the basis of the computational tasks intended to be carried out by the or each the additional computers.

Preferably the method also includes the step of:

(v) additionally transmitting to the or each additional computer one or more associated non-application memory values or contents stored in the local independent memory of each computer on which a replicated application memory location/content is replicated.

Preferably the method also includes the step of:

(vi) notifying each of said computers that the or each additional computer also replicates a replicated application memory location/content.

Preferably the method also includes the step of:

(vii) additionally transmitting to the or each additional computer a table, list, or record of the other ones of said computers in which a replicated application memory location/content of the or each additional computer, is also replicated.

Preferably the method also includes the step of:

(viii) storing in the local independent memory of each computer on which a replicated application memory location/content is replicated, a table, list, or record identifying the ones (or other ones) of said computers in which the replicated application memory location/content is replicated.

The foregoing describes only some embodiments of the present invention and modifications, obvious to those skilled in the computing arts, can be made thereto without departing from the scope of the present invention.

The term “distributed runtime system”, “distributed runtime”, or “DRT” and such similar terms used herein are intended to capture or include within their scope any application support system (potentially of hardware, or firmware, or software, or combination and potentially comprising code, or data, or operations or combination) to facilitate, enable, and/or otherwise support the operation of an application program written for a single machine (e.g. written for a single logical shared-memory machine) to instead operate on a multiple computer system with independent local memories and operating in a replicated shared memory arrangement. Such DRT or other “application support software” may take many forms, including being either partially or completely implemented in hardware, firmware, software, or various combinations therein.

The methods described herein are preferably implemented in such an application support system, such as DRT described in International Patent Application No. PCT/AU2005/000580 published under WO 2005/103926 (and to which US patent application Ser. No. 111/111,946 Attorney Code 5027F-US corresponds), however this is not a requirement of this invention. Alternatively, an implementation of the above methods may comprise a functional or effective application support system (such as a DRT described in the abovementioned PCT specification) either in isolation, or in combination with other softwares, hardwares, firmwares, or other methods of any of the above incorporated specifications, or combinations therein.

The reader is directed to the abovementioned PCT specification for a full description, explanation and examples of a distributed runtime system (DRT) generally, and more specifically a distributed runtime system for the modification of application program code suitable for operation on a multiple computer system with independent local memories functioning as a replicated shared memory arrangement, and the subsequent operation of such modified application program code on such multiple computer system with independent local memories operating as a replicated shared memory arrangement.

Also, the reader is directed to the abovementioned PCT specification for further explanation, examples, and description of various methods and means which may be used to modify application program code during loading or at other times.

Also, the reader is directed to the abovementioned PCT specification for further explanation, examples, and description of various methods and means which may be used to modify application program code suitable for operation on a multiple computer system with independent local memories and operating as a replicated shared memory arrangement.

Finally, the reader is directed to the abovementioned PCT specification for further explanation, examples, and description of various methods and means which may be used to operate replicated memories of a replicated shared memory arrangement, such as updating of replicated memories when one of such replicated memories is written-to or modified.

In alternative multicomputer arrangements, such as distributed shared memory arrangements and more general distributed computing arrangements, the above described above methods may still be applicable, advantageous, and used. Specifically, any multi-computer arrangement where replica, “replica-like”, duplicate, mirror, cached or copied memory locations exist, such as any multiple computer arrangement where memory locations (singular or plural), objects, classes, libraries, packages etc are resident on a plurality of connected machines and preferably updated to remain consistent, then the above methods may apply. For example, distributed computing arrangements of a plurality of machines (such as distributed shared memory arrangements) with cached memory locations resident on two or more machines and optionally updated to remain consistent comprise a functional “replicated memory system” with regard to such cached memory locations, and is to be included within the scope of the present invention. Thus, it is to be understood that the aforementioned methods apply to such alternative multiple computer arrangements. The above disclosed methods may be applied in such “functional replicated memory systems” (such as distributed shared memory systems with caches) mutatis mutandis.

It is also provided and envisaged that any of the described functions or operations described as being performed by an optional server machine X (or multiple optional server machines) may instead be performed by any one or more than one of the other participating machines of the plurality (such as machines M1, M2, M3 . . . Mn of FIG. 1).

Alternatively or in combination, it is also further anticipated and envisaged that any of the described functions or operations described as being performed by an optional server machine X (or multiple optional server machines) may instead be partially performed by (for example broken up amongst) any one or more of the other participating machines of the plurality, such that the plurality of machines taken together accomplish the described functions or operations described as being performed by an optional machine X. For example, the described functions or operations described as being performed by an optional server machine X may broken up amongst one or more of the participating machines of the plurality.

Further alternatively or in combination, it is also further provided and envisaged that any of the described functions or operations described as being performed by an optional server machine X (or multiple optional server m0achines) may instead be performed or accomplished by a combination of an optional server machine X (or multiple optional server machines) and any one or more of the other participating machines of the plurality (such as machines M1, M2, M3 . . . Mn), such that the plurality of machines and optional server machines taken together accomplish the described functions or operations described as being performed by an optional single machine X. For example, the described functions or operations described as being performed by an optional server machine X may broken up amongst one or more of an optional server machine X and one or more of the participating machines of the plurality.

Various record storage and transmission arrangements may be used when implementing this invention. One such record or data storage and transmission arrangement is to use “tables”, or other similar data storage structures. Thus, the methods of this invention are not to be restricted to any of the specific described record or data storage or transmission arrangements, but rather any record or data storage or transmission arrangement which is able to accomplish the methods of this invention may be used.

Specifically with reference to the described example of a “table”, “record”, “list”, or the like, the use of the term “table” (or the like or similar terms) in any described storage or transmission arrangement (and the use of the term “table” generally) is illustrative only and to be understood to include within its scope any comparable or functionally similar record or data storage or transmission means or method, such as may be used to implement the described methods of this invention.

The terms “object” and “class” used herein are derived from the JAVA environment and are intended to embrace similar terms derived from different environments, such as modules, components, packages, structs, libraries, and the like.

The use of the term “object” and “class” used herein is intended to embrace any association of one or more memory locations. Specifically for example, the term “object” and “class” is intended to include within its scope any association of plural memory locations, such as a related set of memory locations (such as, one or more memory locations comprising an array data structure, one or more memory locations comprising a struct, one or more memory locations comprising a related set of variables, or the like).

Reference to JAVA in the above description and drawings includes, together or independently, the JAVA language, the JAVA platform, the JAVA architecture, and the JAVA virtual machine. Additionally, the present invention is equally applicable mutatis mutandis to other non-JAVA computer languages (including for example, but not limited to any one or more of, programming languages, source-code languages, intermediate-code languages, object-code languages, machine-code languages, assembly-code languages, or any other code languages), machines (including for example, but not limited to any one or more of, virtual machines, abstract machines, real machines, and the like), computer architectures (including for example, but not limited to any one or more of, real computer/machine architectures, or virtual computer/machine architectures, or abstract computer/machine architectures, or microarchitectures, or instruction set architectures, or the like), or platforms (including for example, but not limited to any one or more of, computer/computing platforms, or operating systems, or programming languages, or runtime libraries, or the like).

Examples of such programming languages include procedural programming languages, or declarative programming languages, or object-oriented programming languages. Further examples of such programming languages include the Microsoft.NET language(s) (such as Visual BASIC, Visual BASIC.NET, Visual C/C++, Visual C/C++.NET, C#, C#.NET, etc), FORTRAN, C/C++, Objective C, COBOL, BASIC, Ruby, Python, etc.

Examples of such machines include the JAVA Virtual Machine, the Microsoft .NET CLR, virtual machine monitors, hypervisors, VMWare, Xen, and the like.

Examples of such computer architectures include, Intel Corporation's x86 computer architecture and instruction set architecture, Intel Corporation's NetBurst microarchitecture, Intel Corporation's Core microarchitecture, Sun Microsystems' SPARC computer architecture and instruction set architecture, Sun Microsystems' UltraSPARC III microarchitecture, IBM Corporation's POWER computer architecture and instruction set architecture, IBM Corporation's POWER4/POWER5/POWER6 microarchitecture, and the like.

Examples of such platforms include, Microsoft's Windows XP operating system and software platform, Microsoft's Windows Vista operating system and software platform, the Linux operating system and software platform, Sun Microsystems' Solaris operating system and software platform, IBM Corporation's AIX operating system and software platform, Sun Microsystems' JAVA platform, Microsoft's .NET platform, and the like.

When implemented in a non-JAVA language or application code environment, the generalized platform, and/or virtual machine and/or machine and/or runtime system is able to operate application code 50 in the language(s) (possibly including for example, but not limited to any one or more of source-code languages, intermediate-code languages, object-code languages, machine-code languages, and any other code languages) of that platform, and/or virtual machine and/or machine and/or runtime system environment, and utilize the platform, and/or virtual machine and/or machine and/or runtime system and/or language architecture irrespective of the machine manufacturer and the internal details of the machine. It will also be appreciated in light of the description provided herein that platform and/or runtime system may include virtual machine and non-virtual machine software and/or firmware architectures, as well as hardware and direct hardware coded applications and implementations.

For a more general set of virtual machine or abstract machine environments, and for current and future computers and/or computing machines and/or information appliances or processing systems, and that may not utilize or require utilization of either classes and/or objects, the structure, method, and computer program and computer program product are still applicable. Examples of computers and/or computing machines that do not utilize either classes and/or objects include for example, the x86 computer architecture manufactured by Intel Corporation and others, the SPARC computer architecture manufactured by Sun Microsystems, Inc and others, the PowerPC computer architecture manufactured by International Business Machines Corporation and others, and the personal computer products made by Apple Computer, Inc., and others. For these types of computers, computing machines, information appliances, and the virtual machine or virtual computing environments implemented thereon that do not utilize the idea of classes or objects, may be generalized for example to include primitive data types (such as integer data types, floating point data types, long data types, double data types, string data types, character data types and Boolean data types), structured data types (such as arrays and records) derived types, or other code or data structures of procedural languages or other languages and environments such as functions, pointers, components, modules, structures, references and unions.

In the JAVA language memory locations include, for example, both fields and elements of array data structures. The above description deals with fields and the changes required for array data structures are essentially the same mutatis mutandis.

Any and all embodiments of the present invention are to be able to take numerous forms and implementations, including in software implementations, hardware implementations, silicon implementations, firmware implementation, or software/hardware/silicon/firmware combination implementations.

Various methods and/or means are described relative to embodiments of the present invention. In at least one embodiment of the invention, any one or each of these various means may be implemented by computer program code statements or instructions (possibly including by a plurality of computer program code statements or instructions) that execute within computer logic circuits, processors, ASICs, microprocessors, microcontrollers, or other logic to modify the operation of such logic or circuits to accomplish the recited operation or function. In another embodiment, any one or each of these various means may be implemented in firmware and in other embodiments such may be implemented in hardware. Furthermore, in at least one embodiment of the invention, any one or each of these various means may be implemented by a combination of computer program software, firmware, and/or hardware.

Any and each of the aforedescribed methods, procedures, and/or routines may advantageously be implemented as a computer program and/or computer program product stored on any tangible media or existing in electronic, signal, or digital form. Such computer program or computer program products comprising instructions separately and/or organized as modules, programs, subroutines, or in any other way for execution in processing logic such as in a processor or microprocessor of a computer, computing machine, or information appliance; the computer program or computer program products modifying the operation of the computer on which it executes or on a computer coupled with, connected to, or otherwise in signal communications with the computer on which the computer program or computer program product is present or executing. Such computer program or computer program product modifying the operation and architectural structure of the computer, computing machine, and/or information appliance to alter the technical operation of the computer and realize the technical effects described herein.

For ease of description, some or all of the indicated memory locations herein may be indicated or described to be replicated on each machine (as shown in FIG. 4), and therefore, replica memory updates to any of the replicated memory locations by one machine, will be transmitted/sent to all other machines. Importantly, the methods and embodiments of this invention are not restricted to wholly replicated memory arrangements, but are applicable to and operable for partially replicated shared memory arrangements mutatis mutandis (e.g. where one or more memory locations are only replicated on a subset of a plurality of machines, such as shown in FIG. 4A).

Any combination of any of the described methods or arrangements herein are anticipated and envisaged, and to be included within the scope of the present invention.

The term “comprising” (and its grammatical variations) as used herein is used in the inclusive sense of “including” or “having” and not in the exclusive sense of “consisting only of”.

I/We claim:

1. In a replicated shared memory (RSM) type multiple computer system or a partial or hybrid RSM type multiple computer system comprising a plurality of computers each interconnected via a communications system and each operable to execute a different portion of an applications program written to execute on only a single computer, a method of adding one or multiple machines or computers to an existing operating plurality of machines or computers in a replicated shared memory arrangement, said method comprising:
(i) initializing the memory of each said additional computer to at least partially replicate the memory contents of said plurality of computers in each said additional computer.

2. A method for dynamically scaling a replicated shared memory computing systems to increase the size or processing capacity of the computing system dynamically during operation without requiring the system as a whole or the computer program software executing on or within the computer system to be stopped and/or restarted, said method comprising:
configuring a plurality of computers to operate in a replicated shared memory (RSM) type multiple computer system or a partial or hybrid RSM type multiple computer system comprising a plurality of computers each interconnected via a communications system and each operable to execute a different portion of an applications program written to execute on only a single computer;
adding processing elements or processing capacity including adding an additional computer or computers, processors, processor cores, and/or other processing means and additional memory coupled with said processors, processor cores, and/or other processing means;
initializing the added memory of each said additional processing elements or processing capacity dynamically during operation of the plurality of computers to at least partially replicate the memory contents of said plurality of computers in each said additional computer; and
continuing to operate said computing system including said added processing elements or processing capacity without stopping or halting the system as whole or the computer program software executing one or within the computer system.

3. A method as in claim 2, further comprising communicating the memory location information of at least one of the newly added computing machine and the existing plurality of computing machines to computing machines that did not previously have the memory location information.

4. A replicated shared memory computer system including a dynamically added additional computing machine, the replicated shared memory computer system comprising:
an existing plurality N of computing machines each computing machine having its own local memory;
a communications network by which said existing plurality of computing machines are interconnected;
an added computing machine coupled to the communications network;
each of the existing plurality of computing machines N and the added computing machine having a memory location replicated on each of the machines so that the total number of memory locations on each machine are N+1;
a database structure identifying the computing machines that are members of the replicated shared memory computer system; and
means on each said existing computing machine for updating the database structure to identify each of said computing machines belonging to said replicated shared memory computer system including said added computing machine when it is added.

5. A replicated shared memory computer system as in claim 4, further comprising means for communicating the memory location information of at least one of the newly added computing machine and the existing plurality of computing machines to computing machines that did not previously have the memory location information.

6. A database structure for identifying the computing machines that are members of a replicated shared memory computer system, said database structure comprising:
a list of computing machines that are part of said replicated shared memory computing system.
